(19) United States
(12) Patent Application Publication
(10) Pub. No.: US 2025/0025870 A1
(43) Pub. Date: Jan. 23, 2025

(54) DEIONISER FOR A FLUID CIRCUIT, FLUID CIRCUIT COMPRISING SUCH A DEIONISER, METHOD FOR FILLING A DEIONISER

(71) Applicant: HUTCHINSON, Paris (FR)

(72) Inventors: Damien GILLET, Château-Renard (FR); Christophe DONNET, Amilly (FR); Nicolas ARNAULT, Bourron-Marlotte (FR)

(21) Appl. No.: 18/777,742

(22) Filed: Jul. 19, 2024

(30) Foreign Application Priority Data
Jul. 21, 2023 (FR) 2307879

(51) Int. Cl. B01J 47/024; C02F 1/42; C02F 103/02; H01M 8/04029; H01M 8/04044

(52) U.S. Cl. CPC B01J 47/024; C02F 1/42; H01M 8/04029; H01M 8/04044; C02F 2103/023; C02F 2201/005; C02F 2201/006; H01M 2250/20

(57) ABSTRACT

The disclosure relates to a deioniser for a fluid circuit, the deioniser comprising a fluid connection base and a cartridge comprising a body and a cover configured to be attached to the body, the cover comprising a platform connected to a central well, the platform extends transversely with respect to a longitudinal axis (X) and closes an internal cavity of the body, the central well extends inside the body and comprises two adjacent sections. An upper section comprises second orifices covered by a second sieve or comprising this second sieve, the second orifices being configured to allow fluid (F) to pass from the central well into the internal cavity, and the second sieve being configured to retain a resin (A) and prevent it from leaving the internal cavity. A lower section has no orifices.

### CROSS REFERENCE TO RELATED APPLICATION

This patent application claims the benefit and priority of French Patent Application No. 2307879, filed on Jul. 21, 2023, the disclosure of which is incorporated by reference herein in its entirety as part of the present application.

### TECHNICAL FIELD

The disclosure relates to the technical field of filters, in particular ionic filters or deionisers. The disclosure also concerns fluid circuits equipped with such filters.

A deioniser is a special type of filter configured to regulate the level of electrical conductivity of a fluid. This level of conductivity is regulated by controlling the level of ions in the fluid. The deioniser may therefore also be referred to as an ion filter. The nature of the fluid to be filtered is not limiting in the context of the disclosure. However, as will be seen in more detail later in this description, the fluid is typically a coolant circulating in a fuel cell temperature control circuit, typically hydrogen.

The disclosure also relates to the technical field of the methods for filling a filter, for example a deioniser.

### TECHNICAL BACKGROUND

A fuel cell is configured to generate an electrical voltage through a redox reaction, for example to power the electric motor of a vehicle. It takes the form of a stack comprising a cathode and an anode separated from the cathode by an electrolyte, the fuel being reduced by oxidation on the cathode. The fuel cell systems typically comprise a stack of fuel cells wherein each fuel cell has a cooling fluid flowing through it. The term “temperature control circuit” refers to the fluid loop and the elements of the fuel cell system through which the cooling fluid flows through and/or which are involved in cooling the fuel cells.

The fuel cell systems, particularly hydrogen fuel cells, are widely used in the automotive and transport sectors, where more and more electric vehicles are powered by such systems. The deioniser allows to ensure that a low level of fluid conductivity is maintained in the temperature control circuit. The deioniser therefore comprises a granular bed based on an ion exchange resin.

The existing deionisers typically comprise a reservoir equipped with an internal cavity comprising an inlet port and an outlet port through which fluid enters and exits the internal cavity respectively. The ion exchange resin occupies part of the volume of the internal cavity and is located in the path of the fluid, allowing it to regulate the level of conductivity of said fluid. Typically, the deionisers have a tubular shape with means for connection to the circuit at each end. The maintenance operations that need to be performed on these deionisers, for example to change the ion exchange resin, are complex and time-consuming, not to mention the difficulty associated with the overall dimension of these deionisers. In addition, as the deioniser causes a significant pressure drop, a dedicated line for the deioniser is usually provided in the fluid circuit. The problem of regulating the fluid conductivity also arises in the prior art deionisers. Although the permanent recirculation allows all the fluid to be treated, designs have been proposed to better control the distribution of the fluid in the deioniser and thus ensure sufficient exchange between the fluid and the ion exchange resin. However, most existing solutions are not entirely satisfactory.

The document U.S. Pat. No. 10,569,266 A1 discloses a deioniser 5 for a fuel cell cooling circuit 2. The deioniser 5 comprises a base 8 configured to be connected to the cooling circuit 2. In this respect, the base 8 comprises a conduit 9 for the circulation of the coolant and a portion 10 extending perpendicularly to the conduit. The conduit 9 is configured to be mounted on a branch conduit 6 of the circuit. The deioniser 5 also comprises a bell-shaped cartridge 15 configured to receive an ion exchange resin 14. The cartridge 15 is adapted to be removably attached to the perpendicular portion 10 of the base. In such a configuration, it is possible to unscrew the cartridge from the perpendicular portion 10 of the base when a maintenance operation needs to be performed on the deioniser, which greatly simplifies the maintenance operation.

In addition, the cartridge 15 comprises a cylindrical body 15a and a central well 16 in fluid communication with an outlet orifice 12 of the coolant circulation conduit. The cylindrical body 15a and the central well 16 delimit the volume configured to receive the ion exchange resin 14. The coolant enters the cartridge 15 by means of a mesh disc 31a located at the bottom of the cartridge and gradually fills the cartridge 15. It then reaches the interior of the central well via the upper end of the central well and exits through the outlet orifice 12 and exits the cartridge by flowing through the central well 16 to the outlet orifice 12.

However, the coolant is also able to exit the cartridge 15 via a bypass 32 without passing through the ion exchange resin 14. This system is very complex and does not allow precise control of the residence time of the fluid in the cylindrical body 15a, particularly in contact with the ion exchange resin. This residence time depends not only on the fluid flow rate in the cartridge but also on the number and cross-sectional area of the holes in the mesh disc 31a, the length of the central well 16, in particular the distance between the holes in the mesh disc 31a and the upper end of the central well, and the cross-sectional area of the bypass 32. So if another application and/or a change of scale are envisaged, the system will have to be completely redesigned.

The document KR 1261950 B1 discloses a deioniser for a fuel cell cooling circuit. The deioniser comprises a body 10, a cover 20 comprising a cooling water outlet conduit and a base 14 comprising a cooling water inlet conduit. The body 10 is attached to the cover 20 by attachment means 11, 23, 30, and attached to the base 14 by coupling means 167. It contains a removable cartridge 16 coupled to the base 14 by attachment means 1651. The cartridge 16 comprises a cylindrical wall 161 comprising a mesh and a central well 163, installed inside the cylindrical wall 161, through which cooling water from the inlet conduit 12 enters. The ion exchange resin is configured to occupy the volume between the cylindrical wall 161 and the central well 163. The central well 163 also comprises a mesh formed by a plurality of openings extending along the central well 163. The diameter of the openings increases as you move away from the area where the cooling water is injected into the cartridge. The benefits of such an arrangement are not explained.

This device does not allow precise control of the residence time of the fluid in the deioniser, particularly in contact with the ion exchange resin. This is because the openings at the level of the central well extend the full length of the central well, so that when the fluid passes through the openings closest to the lower end of the well, it does not remain in contact with the ion exchange resin long enough and exits the deioniser almost directly. In addition, this affects the fluid flow rate at the level of the furthest openings, so if another application and/or a change of scale is envisaged, a complete resizing of the openings of the central well must be performed to maintain a proper fluid distribution in the deioniser.

If, as described so far, an appropriate regulation of the conductivity level of the fluids may pose difficulties when designing deionisers, particularly when manufacturers are looking to implement these devices on circuits of variable dimensions, the filling of these deionisers may also raise a number of issues. That said, the problems associated with filling do not just concern deionisers, but all filters.

The prior art has also focused on filling cartridge filters. A cartridge filter is a filter comprising a fluid connection base adapted to be connected to the fluid circuit and a cartridge adapted to be removably attached to the base. The above-mentioned documents describe examples of cartridge filters, in particular cartridge deionisers. This type of filter must be distinguished from fixed filters, where the outer frame is generally made from a single piece and it is therefore not possible to separate a cartridge from a base. In cartridge filters, as the cartridge is removable, it is possible to perform the refilling of the cartridge without having to dismantle the base of the fluid circuit.

The document JP-A-2021137771 discloses a method for filling a cartridge 5 of a deioniser type filter. The cartridge 5 is adapted to be removably attached in a case 4 provided for this purpose. The cartridge 5 comprises a central well 6 with which it forms an integral part. It also comprises two mesh elements 7a and 8a which retain the ion exchange resin when the latter is in the cartridge. The method for filling the cartridge is carried out by means of a filling apparatus. The method comprises a step in which the cartridge 5, without the mesh element 8a, is placed on a support 30 so that its top faces the ground. Next, a masking element 13 is placed on an end of the central well facing the filling apparatus so as to close off said end, then the cartridge 5 is filled with ion exchange resin by means of a tap 35. Finally, the cartridge 5 is closed by placing the mesh element 8a on the supports 9 provided for this purpose.

This filling method is highly complex. The cartridge may only be filled from the bottom of the cartridge, i.e. from the edge formed by the mesh element 8a and a cover 8 when these are present. To perform the filling operation, the mesh element 8a and the cover 8 of the cartridge must be removed to leave the inside of the cartridge freely accessible. At the same time, it must be ensured that the inlet orifice of the central well 6 is not accessible, and to this end the central well must be covered with a masking element 13. Once the cartridge 5 has been filled, the latter is resealed with the mesh element 8a and the cover 8, which requires a high degree of precision because the mesh element 8a and the cover 8 have to be fitted around the central well.

The documents US 2009/233134 A1, U.S. Pat. No. 5,707,536 A and EP 3 132 837 A1 disclose deionisers for a fluid circuit.

The disclosure aims to overcome at least some of the above problems.

### SUMMARY

According to a first aspect, the disclosure proposes for this purpose a deionizer for a fluid circuit, the deioniser comprising:
a fluid connection base suitable for being connected to a fluid circuit, this base comprising a fluid inlet port, a fluid outlet port and an attachment interface, and
a cartridge comprising a body and a cover, the body being generally tubular along a longitudinal axis, and comprising a first closed longitudinal end and a second longitudinal end which is configured to be attached to the attachment interface of the base, the body comprising an internal storage cavity suitable for storing an ion exchange resin, the cover being configured to be attached to the second longitudinal end of the body and comprising a platform connected to a central well,
the platform extending transversely with respect to said longitudinal axis and closing the second end of the body and said internal cavity, this platform comprising first orifices covered by a first sieve or comprising this first sieve, the first orifices being configured to allow a fluid to pass from said internal cavity towards the outlet port, and the first sieve being configured to retain the resin and prevent it from leaving the internal cavity, and
the central well extending inside the body and having a generally tubular shape along the longitudinal axis, the central well comprising a first closed longitudinal end located on the side of the first longitudinal end of the body, and a second longitudinal end which is connected to the platform and which is fluidly connected to the inlet port, the central well comprising two sections adjacent between its first and second ends, an upper section located on the side of the first end and comprising second orifices covered by a second sieve or comprising this second sieve, the second orifices being configured to allow the fluid to pass from the central well into the internal cavity, and the second sieve being configured to retain the resin and prevent it from leaving the internal cavity, and a lower section which is located on the side of the second end and which is devoid of orifices.

The deioniser according to the disclosure solves at least some of the problems of the prior art. Unlike prior art deionisers, the disclosure's deioniser allows to ensure that the residence time of the fluid in the deioniser is sufficient to obtain a low level of conductivity in the fluid. In this respect, in the deioniser of the disclosure, there are second orifices only in the upper section of the central well, i.e. the section on the side of the first end. The lower section of the central well on the side of the second end, i.e. the end of the central well that is fluidically connected to the inlet port, has no orifices. This means that when the fluid enters the deioniser, it may not enter the internal cavity directly and exit through the first orifices, having passed through the ion exchange resin over only a very small part of its height. Instead, the fluid is forced to reach the second orifices of the upper section, located on the side of the first end, to pass from the central well into the internal cavity. Incidentally, the fluid is forced to pass through almost the entire height of the ion exchange resin before exiting the deioniser through the outlet port via the first orifices. A residence time of the fluid in the internal cavity is guaranteed compared with the residence time obtained in prior art deionisers, which allows to ensure sufficient exchanges with the ion exchange resin and, subsequently, maintains a low level of conductivity in the fluid.

In addition, unlike the deionisers of the prior art, keeping the fluid conductivity level low may be easily adapted according to the dimensions of the deioniser according to the disclosure and/or the volume of fluid to be treated, on the basis of a limited number of geometric parameters of the deioniser. The residence time of the fluid in the internal cavity is not very dependent on the flow rate of the fluid and is not very dependent on the characteristics of the platform, in particular the dimensions and/or the shape of the first orifices of the platform. In contrast, in prior art deionisers, these parameters have a significant impact on the residence time of the fluid in the internal cavity. As there are second orifices close to the outlet port of these deionisers, this has the effect of making the residence time of the fluid leaving through these orifices very dependent on the parameters of the fluid entering the deioniser and very dependent on the geometric parameters at the outlet of the deioniser, in particular the outlet orifices of the internal cavity.

According to different characteristics of this deioniser according to this first aspect of the disclosure which may be taken together or separately:
the second orifices have increasing diameters along the longitudinal axis, the second orifices having the largest diameters being proximal to the first end while the second orifices having the smallest diameters being distal to the first end;
the second orifices have dimensions, along the longitudinal axis, differing by no more than 10% from the dimensions, along a transverse axis, of the central well and of the inlet port;
the second orifices have centimetric dimensions along the longitudinal axis;
the second orifices are centimetric in size,
the second orifices are angularly distributed around the circumference of the central well;
said second orifices are substantially ellipsoidal in shape;
the longitudinal dimensions of the lower section are at least equal to the longitudinal dimensions of the upper section;
the first orifices are uniformly distributed around the central well, said first orifices having substantially the same diameter or the same transverse dimension;
the central well comprises between four and ten first orifices;
said first orifices are substantially circular in shape;
the platform comprises an upper face, circular in shape, delimited by a peripheral rim extending around the longitudinal axis, this peripheral rim having a cylindrical shape matching an inner rim of the second longitudinal end of the cartridge, said first orifices being formed in the upper face;
the deioniser further comprises a discharge cavity formed by the platform and the base, said discharge cavity extending around the inlet port;
the inlet port comprises a channel for connecting the inlet port to the central well, the connecting channel being substantially straight and opening at the level of the second longitudinal end of the central well;
the base comprises a multi-way valve for connecting the deioniser to the fluid circuit;
the body comprises a dome, located at the level of its first end, this dome being configured to receive the first end of the central well;
the body further comprises an air drain hole and a plug configured to be attached to the air drain hole, the air drain hole and the plug being located at a top of the dome;
the second end of the body comprises first attachment means, and the attachment interface comprises second attachment means complementary to the first attachment means and suitable to cooperate with said first attachment means;
the platform comprises first means for hooking to the cartridge, and the second end of the body comprises second means for hooking to the platform,
the second end of the body comprises openings for loading the ion exchange resin, the cover being configured to move between a filling position, in which the hooking means are free and the openings are open so as to give access to the internal cavity for filling, and a use position, wherein the second hooking means are engaged with the first hooking means and the openings are closed by the platform, by translation of the longitudinal axis, the platform and central well are formed in one-part,
the platform and the central well are separate parts,
the second orifices form annular rows of second orifices around the circumference of the central well,
the second orifices in the same annular row are angularly spaced at an angle of 90°,
the second orifices in the same annular row are angularly spaced at an angle of 180°.

Still according to the first aspect, the disclosure also relates to a fluid circuit, in particular for a vehicle, comprising a stack of fuel cells, a heat exchanger and a deioniser as previously described.

Also according to the first aspect, the disclosure also relates to a method for filling a deioniser, the method comprising the following steps in this order:
providing a cartridge and a cover for a deioniser as previously described, placing the cover in the filling position,
filling the internal cavity with ion exchange resin, and closing the cartridge using the cover.

Advantageously, closing the cartridge causes the resin in the internal cavity to settle or even compress.

According to a second aspect, the disclosure relates to a filter for a fluid circuit, the filter comprising a cartridge comprising a body and a cover comprising a platform, the body having a generally tubular shape along a longitudinal axis, and comprising a closed first longitudinal end and a second longitudinal end which is configured to be attached to the cover, the body comprising an internal storage cavity adapted to store a filter resin, the second longitudinal end of the body comprising lateral openings for loading the filter resin, the cover being configured to translate along the longitudinal axis from a filling position, wherein the lateral openings are open so as to allow the internal cavity to be filled, towards a use position, in which the openings are closed by the platform.

The filter according to the second aspect of the disclosure not only allows the internal cavity to be filled easily, but also allows the cover 20 to be fitted subsequently simply by the user pressing on it. In contrast, in the filters using the prior art, the internal cavity may only be charged/filled from the bottom of the internal cavity, as shown by way of example in the document JP-A-2021137771. The filter is therefore particularly easy to use. The position of the openings, i.e. laterally at the level of the second longitudinal end of the body, is therefore particularly suitable for filling to be performed simply and without having to perform complex and numerous operations to fit or refit the cover.

According to different characteristics of this filter according to this second aspect of the disclosure, which may be taken together or separately:
the platform is connected to a central well having a generally tubular shape along the longitudinal axis, this central well extending inside the body;
said filter is a deioniser;
first notches extend from a first annular rim on an internal surface of the body.
the cartridge comprises two diametrically opposed openings.

The filter according to the disclosure may comprise one or more of the characteristics listed above relating to the deioniser.

Still according to the second aspect, the disclosure relates to a method for filling a filter, the method comprising the following steps in this order:
providing a filter as described above,
putting the cover in the filling position,
filling the internal cavity with the filter resin by means of the lateral openings, and
closing the cartridge by means of the cover.

According to different characteristics of this filling method according to the second aspect of the disclosure, which may be taken together or separately:
the platform comprises first means for hooking to the cartridge and the second end of the body comprises second means for hooking to the platform, the first and second hooking means being free when the cover is in the filling position, the second hooking means being engaged with the first hooking means when the cover is in the use position.
one of the elements chosen from the first hooking means and the second hooking means comprises protuberances, and the other of these elements comprises notches, the protuberances being configured to cooperate by elastic snap-fitting with the notches to ensure that the elements are attached together.
first protuberances are respectively separated from the second protuberances by first spaces, the hooking means comprising legs capable of being inserted into the spaces so as to lock the cover longitudinally relative to the body when the cover is in the position of use.
the cover comprises at least one marking pattern for the filling position and the use position, this pattern being arranged so that, in the filling position, the pattern is fully visible, and in the use position, the pattern is partially visible;
the platform comprises a second annular rim projecting from an external surface of the platform so that in the filling position the second annular rim abuts the first annular rim.

### BRIEF DESCRIPTION OF THE DRAWINGS

Further objects, characteristics and advantages of the disclosure will become clearer in the following description, made with reference to the attached figures, wherein:

FIGS. 1a and 1b illustrate fluid circuits respectively according to a first (FIG. 1a) and a second (FIG. 1b) embodiment of the disclosure,

FIGS. 2a and 2b are perspective views of a deioniser according to a first embodiment of the disclosure in the assembled position (FIG. 2a) and in the disassembled position (FIG. 2b),

FIGS. 3a and 3b are perspective views of a deioniser according to a second embodiment of the disclosure in the assembled position (FIG. 3a) and in the disassembled position (FIG. 3b),

FIGS. 4a and 4b are longitudinal sectional views of a deioniser according to one embodiment of the disclosure,

FIG. 4c is a top view of a cover for a deioniser as shown in FIGS. 4a and 4b;

FIGS. 5a to 5c are perspective and cross-sectional views respectively of a deioniser cartridge according to the first embodiment at the various steps of a cartridge filling method,

FIG. 6 illustrates the various steps in a method for filling the cartridge of a deioniser according to one embodiment of the disclosure,

FIG. 7 is a perspective view of two deioniser platforms according to different embodiments of the disclosure,

FIG. 8 is a perspective view of two central wells of a deioniser according to different embodiments of the disclosure, and

FIG. 9 is a cross-sectional view of a deioniser cartridge according to one embodiment of the disclosure.

### DETAILED DESCRIPTION

In this description, the terms “upper” and “lower” are not configured to be restrictive, but simply to provide a better understanding of the disclosure with reference to the illustrated figures. The use of the term “lower” simply indicates that the element in question is closer to a lower edge of the filter than an element to which the term “upper” is associated, the lower edge being the one closest to the ports of the filter in the figures shown.

The disclosure will now be described with reference to the attached figures.

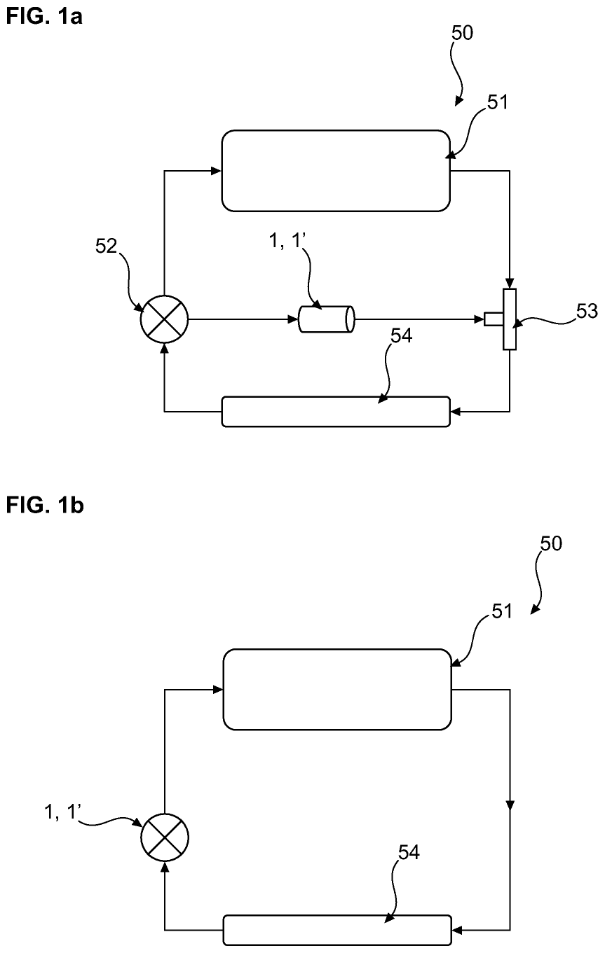

FIGS. 1a and 1b illustrate fluid circuits 50 according to one embodiment of the disclosure. In the examples shown, the fluid circuit 50 is a cooling circuit for vehicles, for example cars, powered by a stack of fuel cells. In this respect, the fluid circuits 50 illustrated basically comprise a fuel cell stack 51, a heat exchanger 54 and a filter 1′. The arrows on the fluid circuit 50 indicate the orientation of flow of the fluid F within the fluid circuit 50.

The operation of the fuel cell stack 51 was described in the introduction and is not repeated here. In addition, as already mentioned, any other type of fluid circuit 50 could be used. The role of the heat exchanger 54 is to exchange heat with the cooling fluid F, after the latter has passed through the stack 51, and to distribute the heat absorbed by said cooling fluid F to the rest of the vehicle, essentially for the purposes of heating and/or air conditioning and/or dehumidifying the air in the passenger compartment. As it passes through the stack 51, the cooling fluid F becomes charged with ions and its conductivity needs to be regulated to prevent a premature degradation of the fluid circuit 50. According to a first aspect of the disclosure, it is the filter 1′, which is a deioniser, which provides this conductivity control.

In the embodiment shown in FIG. 1a, the elements of the fluid circuit 50 are connected in parallel. In addition to the elements already mentioned, the fluid circuit comprises a valve 52 and a conventional T-connector 53. The fluid circuit 50 comprises a first branch comprising the heat exchanger 54 and a second branch, parallel to the first branch, comprising the deioniser 1. The T-shaped connector 53 is used to distribute the cooling fluid F leaving the stack 51 and the deioniser towards the exchanger 54, while the valve 52 is used to distribute the cooling fluid F leaving the exchanger 54 towards the stack 51 and the deioniser 1. In this way, the process by which cooling takes place in the circuit is independent of the process by which the conductivity of the cooling fluid F is regulated. Under these conditions, if any work needs to be implemented on the deioniser 1, the cooling loop for the cooling fluid F is not affected. Similarly, if work has to be carried out on the heat exchanger 54, the control loop of the conductivity of the cooling fluid F is not affected.

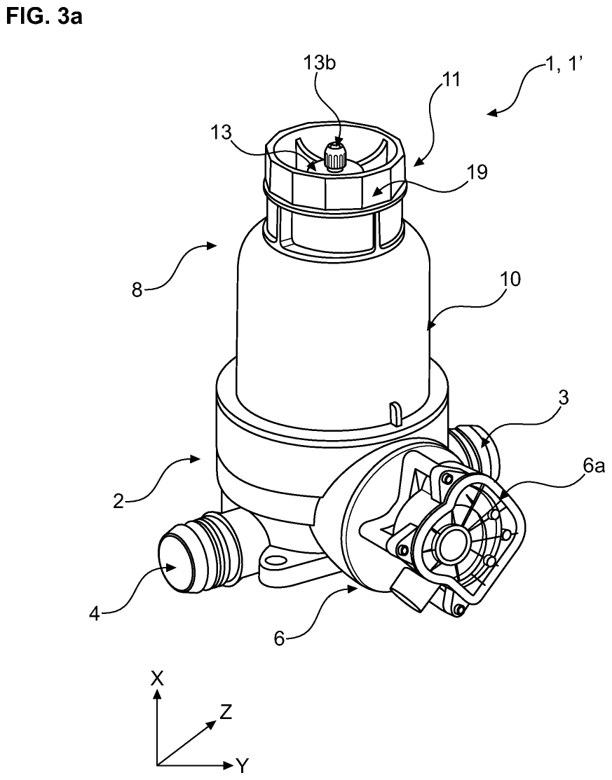

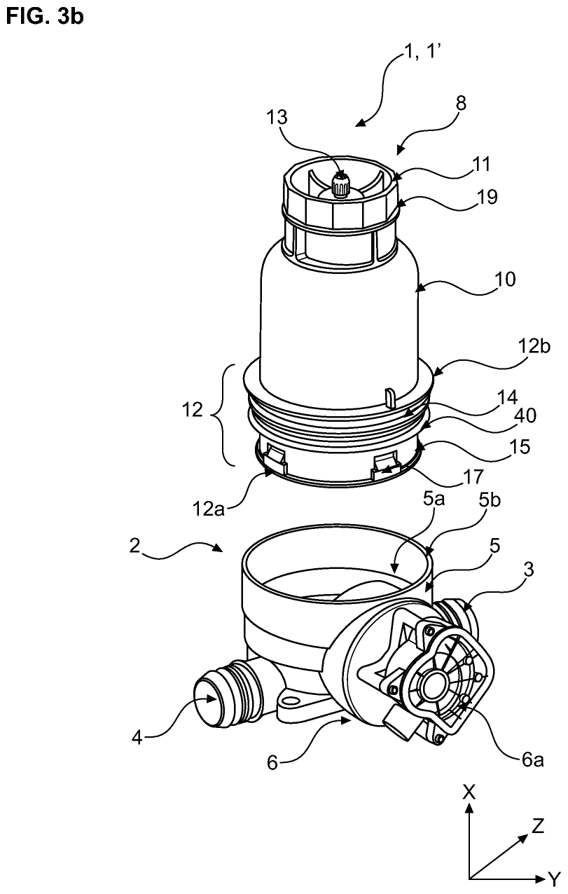

However, this fluid circuit 50 (FIG. 1a) is more complex to manufacture and requires a greater number of elements. In the embodiment shown in FIG. 1b, the elements of the fluid circuit 50 are connected in series. This includes the stack 52, the exchanger 54 and the deioniser 1. In this fluid circuit 50, the deioniser 1 is equipped with a multi-way valve 6 which allows it to control the distribution of the cooling fluid F in the circuit. We will come back to this in the description of FIGS. 3a and 3b. The advantage of such a configuration is that it allows the circuit and its manufacture to be simplified, which is made possible because there is no longer any isolated valve 52, parallel branches or T-connector 53.

Such fluid circuits 50 are used to better understand the disclosure, however, the fluid circuit 50 according to the disclosure is not limited to a cooling circuit 50 for motor vehicles, still less a cooling circuit 50 comprising a stack of fuel cells. The fluid circuit 50 according to the disclosure may be used in all areas requiring a filtration by means of a filter 1′ according to the disclosure. With regard to the deioniser 1, which will be described more particularly below and which constitutes a first aspect of the disclosure, it should be noted that it may, by way of example, be used in any fluid circuit 50 requiring a regulation of the conductivity of a fluid. The fluid circuit 50 may therefore be any water deionisation circuit, whether the water is configured for laboratory, industrial or consumer use.

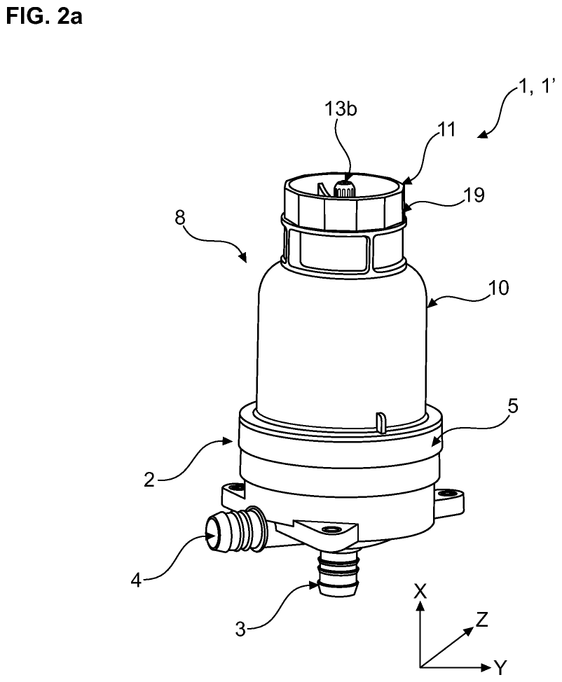

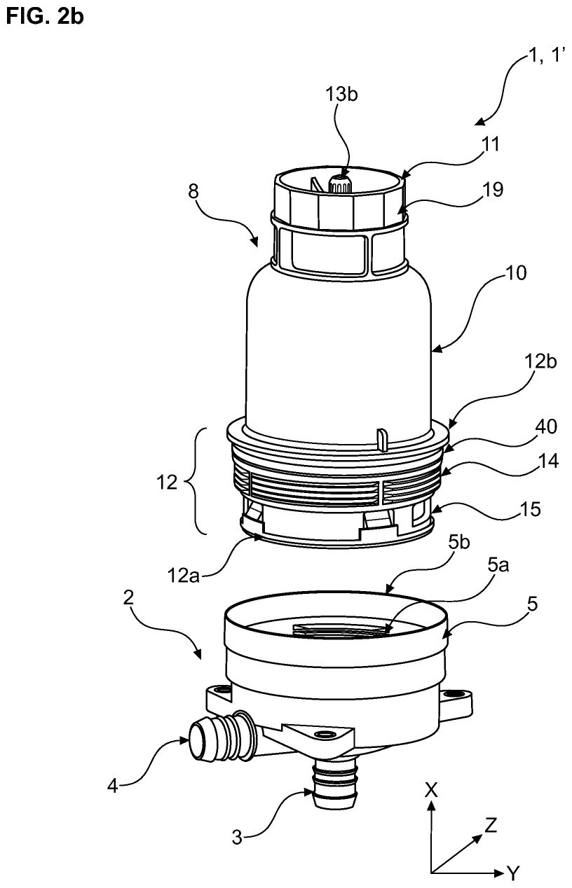

FIGS. 2a and 2b illustrate a deioniser 1 according to a first embodiment of the present disclosure suitable for use in a fluid circuit 50 configured to regulate the conductivity of a fluid, such as, for example, those seen in FIGS. 1a and 1b. The deioniser 1 is a cartridge deioniser, i.e. a deioniser comprising a fluid connection base 2 that may be connected to the fluid circuit 50 and a cartridge 8 that may be removably attached to the base 2. When work needs to be done on the deioniser 1, the cartridge 8 may be removed from the base 2 without having to dismantle the whole deioniser 1, i.e. the deioniser with the base 2. Incidentally, the base 2 may be permanently installed in the fluid circuit 50.

In this respect, the base 2 has a generally tubular shape along a longitudinal axis X. It comprises a fluid inlet port 3 and a fluid outlet port 4 allowing the fluid F to enter the deioniser 1 and to leave the deioniser 1 respectively. It should be noted that the inlet port 3 and outlet port 4 could be located on the cartridge 8 instead of on the base 2. However, in this case, there would no longer be any point in using a cartridge 8 which is separate from a base 2 and which may be detached from this base, for the reasons already mentioned. In this case, it would no longer be a cartridge deioniser 1 but a fixed deioniser 1.

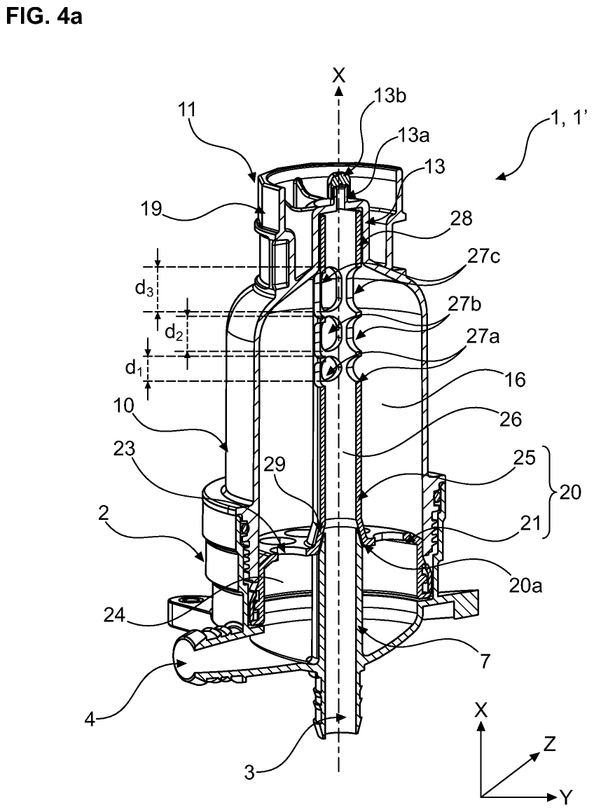

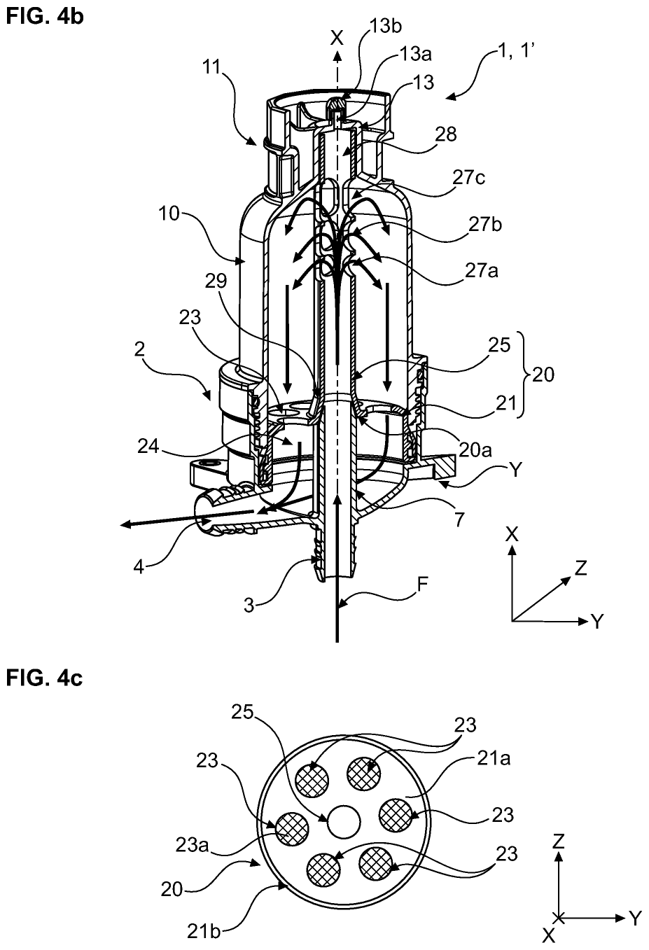

Let's return to the fluid circuit 50 shown in FIG. 1a. The deioniser 1 could be implemented there by fluidly connecting the inlet port 3 to the valve 52 and fluidly connecting the outlet port 4 to the T-connector 53. If the deioniser 1 comprises an integrated multi-way valve 6, as illustrated in FIGS. 4a and 4b, it could be installed in the fluid circuit 50 by connecting the inlet port 3 to the exchanger 54 and connecting the outlet port to the stack 51. We will come back to this in the following. That said, as already mentioned, the deioniser 1 may be installed on any other conductivity control circuit. The base 2 also comprises an attachment interface 5 to which the cartridge 8 may be attached. This attachment interface 5, which is located close to an upper edge of the base, will be described more fully below.

FIGS. 3a and 3b illustrate a deioniser 1 according to a second embodiment of the present disclosure, suitable for use in a fluid circuit 50 configured to regulate the conductivity of a fluid. Unlike the deioniser 1 of the first embodiment, this deioniser 1 comprises a multi-way valve 6 allowing the distribution of the fluid F through the cartridge 8 to be managed while guaranteeing a continuity of the fluid circulation within the fluid circuit 50. In addition, during the maintenance operations to replace the cartridge 8, the multi-way valve 6 allows the fluid supply F towards the cartridge 8 to be shut off, thus avoiding a complete draining of the fluid circuit 50. Incidentally, by integrating the multi-way valve 6 into the base, the pipes, connections and the elements of the second parallel branch are eliminated. In the example embodiment shown in FIG. 1a, these comprise the valve 52, the pipes of the second parallel branch and the T-shaped connector 53.

In the embodiment shown in FIGS. 3a and 3b, the multi-way valve 6 is integrated into the base 2 of the deioniser. More specifically, the multi-way valve 6 is attached to a wall of the base 2. It comprises a drive mechanism (not visible), and an actuator 6a which allows to control the drive mechanism in order to open or close the access path to the deioniser 1 when required. In this respect, the drive mechanism is connected to a valve (not visible) which is able to move to selectively open and close an access path connecting the inlet port 3 and the outlet port 4. Preferably, the multi-way valve 6, the inlet port 3 and the outlet port 4 are therefore arranged in a T-shaped configuration, which allows to simplify the opening and closing of the access path. We will come back to this later to describe the arrangement of these elements in relation to the internal elements of the deioniser 1.

Unless otherwise stated, the following description applies equally to the deionisers, for example in the two embodiments described above.

The cartridge 8 comprises a body 10 and a cover 20 (visible in FIGS. 4a and 4b). The body 10 has a generally tubular shape along the longitudinal axis X. The body 10 comprises a first closed longitudinal end 11 and a second longitudinal end 12 which is configured to be attached to the base attachment interface 5. As the first longitudinal end 11 is closed, the fluid F which enters the deioniser 1 may only leave it by following a path leading to the outlet port 4. The second longitudinal end 12 may advantageously comprise first attachment means 14 capable of cooperating with second attachment means 5a complementary to the attachment interface 5 in order to mount the cartridge 8 removably on the base 2.

In the embodiment illustrated in the figures, the first attachment means 14 consist of a thread, for example of helical shape, formed on an external surface of the cartridge 8, while the second means 5a consist of a complementary thread formed on an internal surface of the base 2. This allows the cartridge 8 to be mounted and removed from the base 2 by screwing and unscrewing respectively. This makes it much easier to mount and remove the cartridge. The deioniser 1 according to the disclosure is not limited to such attachment means, and other attachment means allowing the cartridge 8 to be removably mounted on the base 2 may be envisaged by the person skilled in the art without prejudice to the disclosure.

In this respect, as may be seen more clearly in FIGS. 2b and 3b, the deioniser 1 may also comprise a seal 40 to ensure that it is watertight at the level of the attachment interface 5. The second longitudinal end 12 comprises an annular stop 12b close to which the seal 40 is positioned. The attachment interface comprises an upper edge 5b designed to bear in a sealed manner against the annular stop 12b when the cartridge 8 is mounted on the base 2, said bearing being sealed by the seal 40.

In addition, as may be seen in FIGS. 2a to 3b, the first longitudinal end 11 may advantageously comprise a polyhedral profile 19 which is configured so that it may be gripped by an appropriate tool. The dimensions and the shape of the profile 19 may be adapted to standard tools or, alternatively, if the dimensions and shape of the profile 19 are not adapted to those of standard tools, the tool may be adapted for such use.

The body 10 also comprises an internal storage cavity 16 capable of storing an ion-exchange resin A. The ion exchange resin A is an active material with which the fluid F may carry out ion exchanges to regulate its conductivity. The ion exchange resin A is advantageously in the form of beads or grains, generally between 0.2 mm and 2 mm in diameter. Preferably, the resin A is made from polypropylene random copolymer (PPR) or polyphenylene sulphide (PPS). These materials allow sufficient ion exchange without themselves releasing a quantity of ions that would degrade or cancel out the deionising effect. However, PPS is preferred to PPR because it is more chemically stable. That said, it is less flexible, i.e. less deformable, than PPR and more expensive.

FIGS. 4a and 4b, which are longitudinal cross-sectional views along the longitudinal axis X of a deioniser 1 according to the first embodiment, provide a better view of the internal cavity 16 and the cover 20. However, it should be noted that the cartridge 8 and the cover 20 as described below in relation to this first embodiment are identical in the second embodiment. In fact, only the base 2 and the arrangement of its elements in relation to the cartridge 8 and to the cover 20 may differ between the first and the second embodiment.

As illustrated, the internal cavity 16 occupies a large part of the internal volume of the cartridge 8, which means that a large volume of ion exchange resin A may be stored in the cartridge. In FIGS. 4a and 4b, the deioniser 1 is shown in the assembled position, i.e. the cover 20 is attached to the second longitudinal end 12 of the body and the cartridge 8 is mounted on the base 2. The cover 20 comprise a central well 25 and a platform 21 connected to this central well 25 by a joining 20a. The platform 21 and the central well 25 are described in more detail below. It should first be noted that, in the illustrated embodiments, the deioniser 1 has centimetric dimensions. That said, it may be larger, depending on its intended use.

In the assembled position, the platform 21 extends transversely to the longitudinal axis X and closes the second end 12 of the body and said internal cavity 16. In fact, the internal cavity 16 is closed on the one hand by the first longitudinal end 11 (which is always closed), and on the other hand by the platform 21 which obstructs the second longitudinal end 12 (closed when the deioniser 1 is in the assembled position) and which therefore forms a physical boundary of the internal cavity. In the example embodiment shown, the platform 21 has a substantially cylindrical shape. The platform 21 comprises an upper face 21a delimited by a peripheral rim 21b extending around the longitudinal axis X. As may be seen more clearly in the top view shown in FIG. 4c, the upper face 21a is circular in shape and centered around the longitudinal axis X. The peripheral rim 21b, for its part, has a cylindrical shape that matches an inner rim of the second longitudinal end 12 of the cartridge. In this respect, the dimensions of the platform 21 may be chosen appropriately to allow a precise fit of the cover 20 in the cartridge 8 once said cover 20 is mounted in the cartridge. When the cover 20 is mounted in the cartridge 8, there is little or no clearance between the cover and the cartridge.

The platform 21 comprises first orifices 23 configured to allow fluid F to pass from said internal cavity 16 towards the outlet port 4. These first orifices 23 may be seen more clearly in FIG. 4c. In the example embodiment shown in FIG. 4c, the first orifices 23 are uniformly distributed around the central well 25, and have substantially the same diameter or transverse dimension, which favors a homogeneous distribution of the flows of fluid F flowing from the internal cavity 16 towards the outlet port 4. Advantageously, the first orifices 23 are formed in the upper face 21a of the platform. Although there are six first orifices 23 in FIG. 4c, at least four first orifices 23 and preferably up to ten first orifices 23 may be provided on the platform (FIG. 7). This represents a good compromise between achieving sufficient flow speed and simplifying the method for manufacturing the platform 21. The diameter of said first orifices 23 should then be adapted according to the number of these first orifices. The greater this number, the smaller the diameter of the first orifices 23. The smaller the number of first orifices 23, within the limit stated above (four), the greater the flow cross-section and the lower the pressure drop. FIG. 7, on the right-hand side of the Figure, illustrates a variant embodiment wherein the platform 21 comprises four first orifices 23. In this respect, although the first orifices 23 are circular in shape in the examples embodiment shown, they may be any other shape as long as they allow the fluid F to pass from the internal cavity 16 to the outlet port.

As may also be seen in FIG. 4c, the first orifices 23 are covered by a first sieve 23a or comprise the first sieve 23a. The first sieve 23a is configured to retain the ion-exchange resin A and prevent it from leaving the internal cavity 16, and in particular from entering a discharge cavity 24 formed by the platform 21 and the base 2. In practice, the dimensions of the first orifices 23 are considerably larger than those of the beads making up the ion exchange resin A, i.e. each orifice has dimensions at least one order of magnitude larger than those of a bead of the resin A. Without the first sieve 23a, the beads would therefore be discharged towards the outlet port 4 under the effect of gravity and of the fluid F passing through the deioniser 1. In this respect and preferably, the first sieve 23a comprises openings whose maximum dimensions are strictly smaller than the dimensions of the beads making up the ion exchange resin A. Preferably, the first sieve may be made from the same material as the rest of the cover 20, making it easier to recycle.

At this point, it should be emphasized that the aforementioned discharge cavity 24 does not simply serve as a communication channel for the fluid F leaving the internal cavity 16. The discharge cavity 24 extends around the inlet port 3, and more specifically around a channel 7 in the inlet port. This channel 7 occupies a substantially central position in the discharge cavity 24 and will be described in more detail later in this description. It should also be noted that the discharge cavity 24 is delimited longitudinally by the upper face 21a of the platform and by a lower edge (not referenced) of the base 2. It is also bounded laterally by the peripheral edge 21b of the platform.

The central well 25 is generally tubular along the longitudinal axis X. It extends inside the body 10 when the cover 20 is placed on the cartridge 8. In the embodiment illustrated in the figures, it extends from a central area of the upper face 21a of the platform (FIG. 4c) so that when the deioniser 1 is in the assembled position (FIGS. 4a and 4b), the central well 25 occupies a central position inside the internal cavity 16. In this way, the distribution dynamics of the fluid F in the internal cavity 16 depends very little on the geometry of the internal cavity 16 itself, since the flow conditions are uniform around the central well 25.

In addition, the central well 25 comprises a first closed longitudinal end 28 which is located on the same side as the first longitudinal end 11 of the body. In practice, the first longitudinal end 28 of the central well is closed by the first longitudinal end 11 of the body. In a preferred embodiment, the first longitudinal end 11 of the body comprises a dome 13 configured to receive the first end 28 of the central well. The dome 13 comprises a top and, in addition, an air drain hole 13a and a plug 13b located at the level of its top. The air drain hole 13a is used to drain the internal cavity 16, i.e. to discharge the excess air contained in the internal cavity 16 when the cartridge is filled. The plug 13b is configured to be attached to the air drain hole 13a so that this air drain hole 13a is always closed unless draining is required when the cartridge 8 is filled. The plug 13b is only separated from the air drain hole 13a when the internal cavity 16 is drained. Thus, when the deioniser 1 is in the assembled position, as shown in the figures, the first longitudinal end 11 of the body is always closed. At the same time, as the first longitudinal end 28 of the central well is received in the dome 13, it is also closed by the first longitudinal end 11 of the body. It should be noted that the dome 13 is not compulsory and that the first longitudinal end 11 could quite easily be closed by a simple wall following the contours of the first longitudinal end 28 of the central well.

The central well 25 also comprises a second longitudinal end 29 which is connected to the platform 21 and is fluidically connected to the inlet port 3. In the embodiments illustrated in the figures, the second longitudinal end 29 is connected to the platform 21 by means of the joining 20a connecting the platform 21 and the central well 25. As already mentioned and visible in the figures, the inlet port 3 comprises the connection channel 7. This connection channel 7 extends as far as the central well 25. More specifically, it opens directly at the level of the second longitudinal end 29 of the central well when the deioniser 1 is in the assembled position, creating a path for the fluid F arriving via the inlet port 3. In the illustrated embodiment, the connection channel 7 is substantially straight. However, it may have any other appropriate shape depending on the position of the inlet port 3. This connection channel 7 may, for example, be L-shaped for a deioniser 1 in the second embodiment (FIGS. 3a and 3b).

In this respect, as in the embodiment illustrated in FIGS. 4a and 4b, the central well 25 and the connection channel 7 are aligned along the longitudinal axis X, i.e. the central well 25 extends in the continuity of the inlet port 3, parallel to the connection channel 7 and in the extension of said connection channel 7, when the fluid F moves in the inlet port 3 and in the central well, it does not undergo any slowdown apart from that possibly caused by its own weight. Preferably, the joining 20a follows the contours of one end of the proximal connection channel of the second longitudinal end 29 of the central well when the deioniser 1 is in the assembled position. This allows to stabilize the connection between the central well 25 and the inlet port 3.

In the deioniser 1 of the second embodiment, this is not the case, as the inlet port 3 is not aligned with the central well 25. The inlet port 3 is aligned with the outlet port 4 and, possibly, the valve of the multi-way valve 6. The connection channel 7 is L-shaped, which is likely to slow down the fluid F slightly, so this should be taken into account when the fluid flow rate is set.

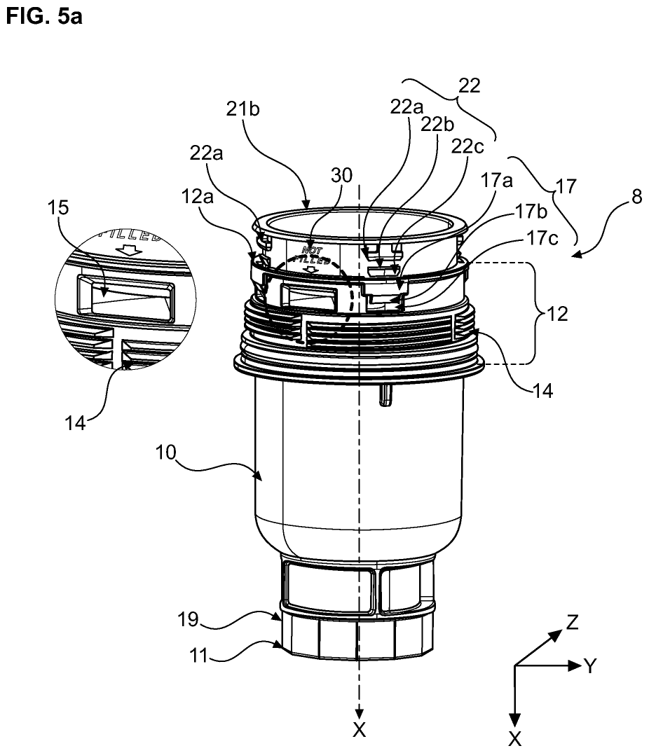

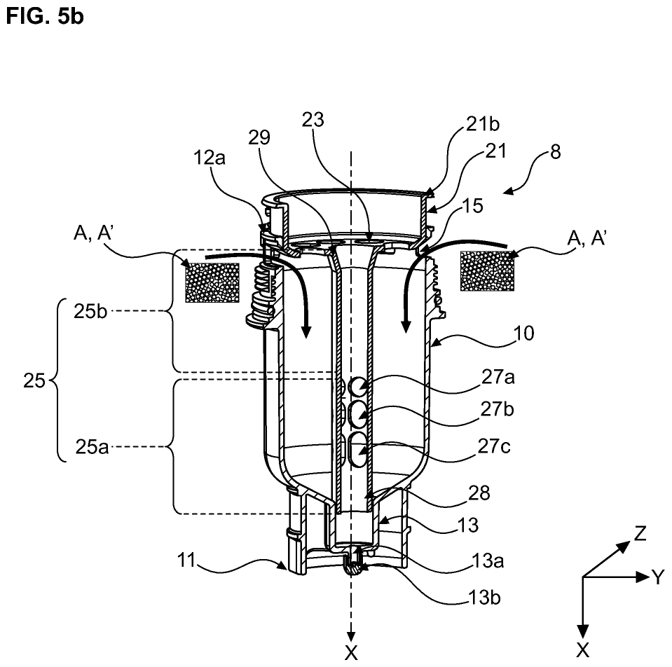

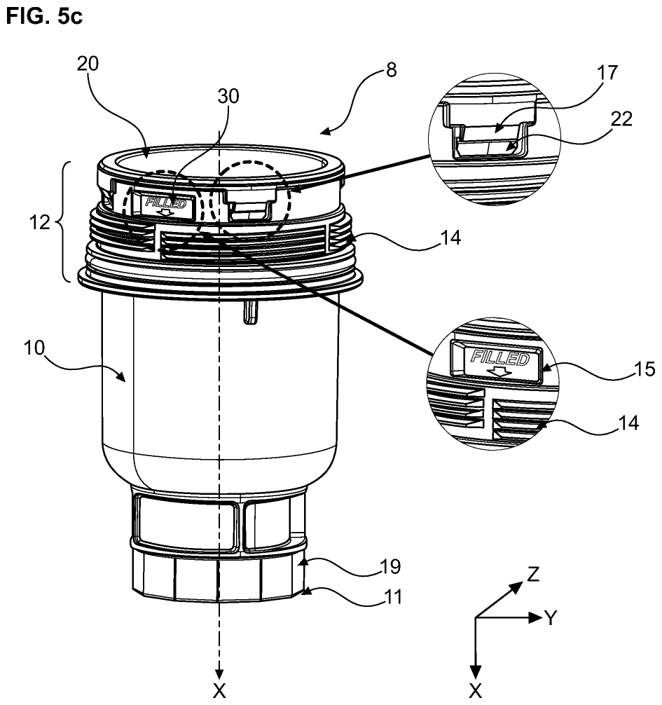

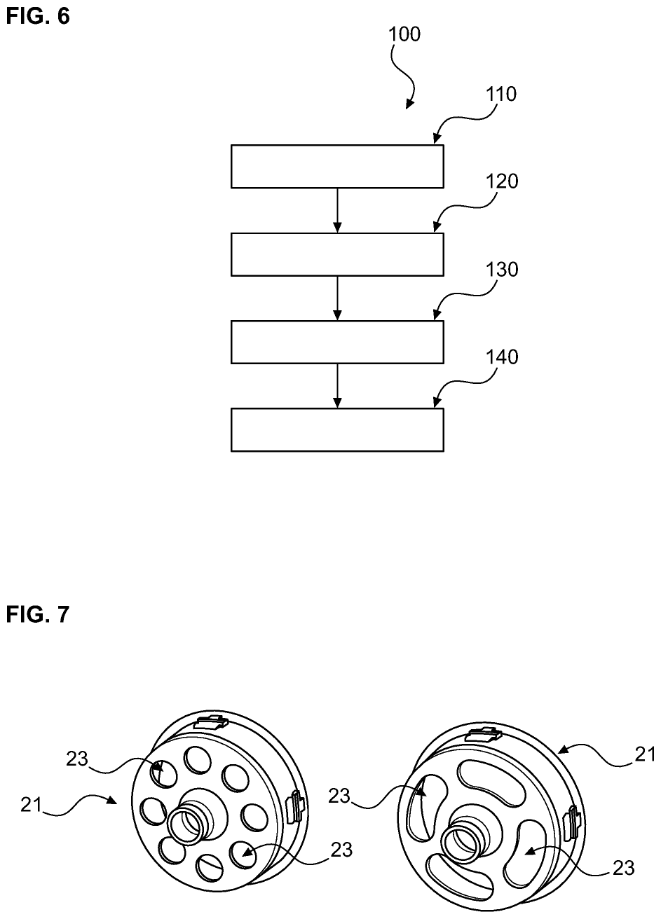

According to a first aspect of the disclosure, the central well 25 comprises two adjacent sections 25a, 25b (visible in FIG. 5b) between its first 28 and second 29 ends. According to the first aspect of the disclosure, an upper section 25a is located next to the first longitudinal end 28 and comprises second orifices 27a, 27b, 27c covered by a second sieve or comprising this second sieve. The second orifices 27a, 27b, 27c are configured to allow the fluid F to pass from the central well 25 into the internal cavity 16, and the second sieve is configured to retain the ion-exchange resin A and prevent it from leaving the internal cavity 16 to reach the inside of the central well 25. Still according to the first aspect of the disclosure, a lower section 25b is located on the side of the second end 29 and has no orifices. Referring more specifically to FIG. 4b, when the fluid F enters the deioniser 1, it passes successively through the fluid inlet port 3, the lower section 25b, the upper section 25a, the second orifices 27a, 27b, 27c, the ion exchange resin A, the first orifices 23, the platform 21—in particular the discharge cavity 24 formed by the platform 21 and the base 2—and the outlet port 4.

In the deioniser 1 according to the first aspect of the disclosure, the central well 25 comprises second orifices 27a, 27b, 27c only at the level of its upper section 25a, i.e. the section located on the side of the first longitudinal end 11 of the body. So when the fluid F enters the deioniser 1, it may not directly enter the internal cavity 16. It is forced to cover the entire lower section 25b before reaching the second orifices 27a, 27b, 27c. It may not therefore pass through more than a tiny part of the ion exchange resin A and is instead forced to reach the second orifices 27a, 27b, 27c of the upper section 25a in order to pass from the central well 25 into the internal cavity 16. The fluid F is therefore forced to pass through the ion exchange resin A over almost its entire height before leaving the deioniser 1 through the outlet port 4 via the first orifices 23. The residence time of the fluid F in the internal cavity 16 is therefore significantly extended compared with prior art deionisers, which allows to ensure sufficient exchange with the ion exchange resin A for the conductivity level in the fluid to be low.

In addition, unlike the deionisers of the prior art, maintaining the fluid conductivity level at a low level may be easily adapted with the deioniser 1 according to the disclosure depending on the volume of fluid to be treated, on the basis of a limited number of geometric parameters of the deioniser 1. The residence time of the fluid F in the internal cavity 16 depends little on the flow rate of the fluid and little, if any, on the characteristics of the platform 21, in particular the dimensions and/or the shape of the first orifices 23 of the platform. In contrast, in prior art deionisers, these parameters have a significant impact on the residence time of the fluid in the internal cavity 16. As there are second orifices close to the outlet port of these deionisers, this has the effect of making the residence time of the fluid leaving through these orifices very dependent on the parameters of the fluid entering the deioniser and very dependent on the geometric parameters at the outlet of the deioniser, in particular the outlet orifices of the internal cavity.

As previously mentioned, the upper section 25a comprises second orifices 27a, 27b and 27c. In the embodiment illustrated in FIGS. 4a, 4b, 5a, 5b and 5c, the second orifices 27a, 27b, 27c are distributed both longitudinally, i.e. along the longitudinal axis X, and angularly around the entire circumference of the central well 25. There are therefore a plurality of second orifices, 27a, 27b and 27c respectively, along the longitudinal axis X and, at a given height, there are also a plurality of second orifices around the entire circumference of the central well 25 forming annular rows of second orifices. In this way, the upper section 25a comprises a plurality of second orifices 27a distal from the first longitudinal end 28 which are located at the same height. Similarly, the upper section 25a comprises a plurality of second orifices 27c proximal to the first longitudinal end 28 which are located at the same height. The same applies to all the second intermediate orifices 27b located between the second distal orifices 27a and the second proximal orifices 27c of the first longitudinal end 28 of the central well. As also illustrated in FIGS. 4a, 4b, 5a, 5b and 5c, and FIG. 8, on the left of the figure, the second orifices 27a, 27b and 27c are circumferentially distributed every 90°, i.e. the second orifices 27a, 27b and 27c in the same annular row are angularly spaced at an angle of 90°. In principle, therefore, there may be up to four second orifices 27a, 27b, 27c per annular row. This configuration requires the use of drawer molds to manufacture the central well 25.

In this respect, if, as illustrated in the figures, the upper section 25a comprises only one annular row of intermediate second orifices 27b—and therefore three annular rows of second orifices 27a, 27b, 27c, the upper section 25a could comprise more annular rows of intermediate second orifices 27b, 27b′ (not illustrated), 27b″ (not illustrated), etc. if the dimensions of the deioniser 1 were to be increased.

As also illustrated in FIGS. 4a and 4b, the second orifices 27a, 27b and 27c are substantially ellipsoidal in shape. However, the second orifices 27a, 27b, 27c could have any other desired shape. For the purposes of the disclosure, it is only important that the second orifices are capable of allowing the fluid F to pass from the central well 25 into the internal cavity 16. The same applies to the dimensions of said second orifices 27a, 27b, 27c. This being said, it is advantageous for the second orifices 27a, 27b, 27c to have dimensions, along the longitudinal axis X, differing by no more than 10% from the dimensions, along a transverse axis Y, of the central well 25 and of the inlet port 3. In other words, it is advantageous that the respective diameters of the longitudinal sections of the second orifices 27a, 27b, 27c, the cross-section of the central well 25 and the cross-section of the inlet port 3 do not differ by more than 10%. This avoids creating geometric singularities and generating sudden changes in the speed and behavior of the fluid F inside the deioniser 1. Preferably, the respective diameters of the longitudinal sections of the second orifices 27a, 27b, 27c, the cross-section of the central well 25 and the cross-section of the inlet port 3 are centimetric.

In this respect, according to a particularly advantageous embodiment of the deioniser 1, the second orifices 27a, 27b, 27c have increasing diameters d₁, d₂, d₃ along the longitudinal axis X, the second orifices 27c proximal to the first longitudinal end 28 having the largest diameters d₃ while the second orifices 27a distal to the first longitudinal end 28 have the smallest diameters d₁. In other words, the diameter of the second orifices 27a, 27b, 27c increases along the longitudinal axis X in the direction of movement of the fluid F. In other words, the further the second orifices 27a, 27b, 27c are from the second longitudinal end 29, the greater their diameter. Such a configuration allows to obtain a higher fluid flow rate in an area of the internal cavity 16 which is furthest from the first orifices 23 and a lower fluid flow rate in an area of the internal cavity 16 which is closer to the first orifices 23 than the area passed through by a higher fluid flow rate. In this way, the fluid F which enters the internal cavity 16 through the second distal orifices 27a of the first longitudinal end 28—closer to the inlet port 3—has a sufficiently low velocity when it enters the internal cavity 16 to have time to make exchanges with the ion exchange resin A. At the same time, the fluid F which enters the internal cavity 16 through the second proximal orifices 27c of the first longitudinal end 28—further away from the inlet port—has a sufficiently high speed to reach said second proximal orifices 27c and to carry out sufficient exchanges with the ion exchange resin A.

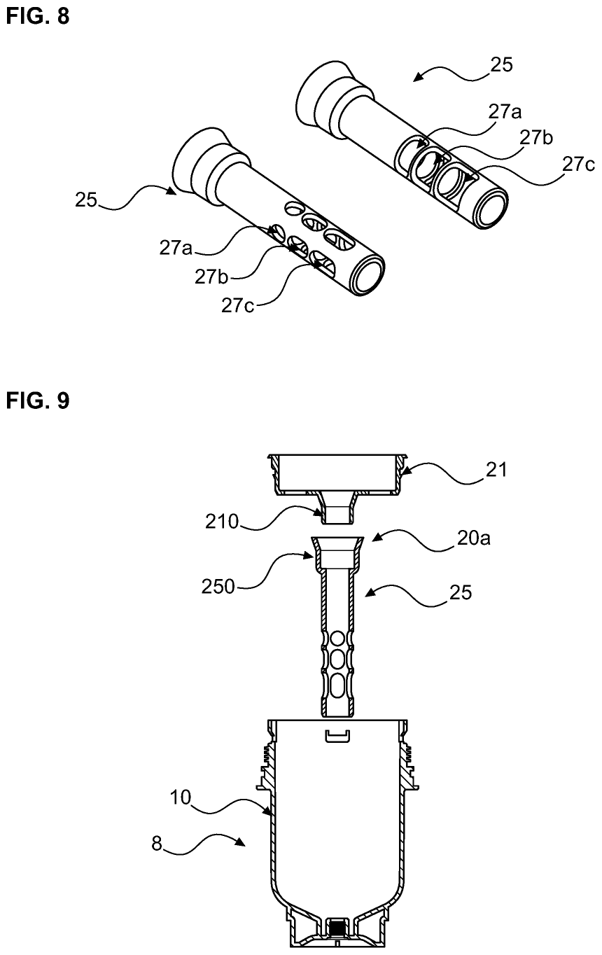

According to a particular implementation illustrated in FIG. 8, on the right of the figure, the second orifices 27a, 27b and 27c are circumferentially distributed every 180°, i.e. the second orifices 27a, 27b and 27c in the same annular row are angularly spaced at an angle of 180°. In principle, therefore, there may be up to two second orifices 27a, 27b, 27c per annular row. This configuration is simpler than that previously seen with reference to FIGS. 4a, 4b, 5a, 5b and 5c, as it requires the use of simpler molds than the drawer molds for the manufacture of the central well 25. This type of mold may be described as a “waffle” mold because it does not require as complex a set-up as that required for the drawer molds. This also allows to increase the cross-sectional area through which the fluid may pass and limits the pressure drop.

As already mentioned, the second orifices 27a, 27b, 27c are covered by a second sieve (not shown). The second sieve is configured to retain the ion exchange resin A and prevent it from leaving the internal cavity 16, and in particular from entering the central well 25. Like the first orifices 23 and in practice, the second orifices 27a, 27b, 27c have dimensions significantly greater than those of the beads making up the ion exchange resin A, i.e. each second orifice 27a, 27b, 27c has dimensions at least one order of magnitude greater than those of the beads of the resin A. Without the second sieve, the beads could reach the central well 25 and considerably reduce the flow rate of the fluid F as it passes through the deioniser 1. In this respect and preferably, the second sieve comprises openings whose maximum dimensions are strictly smaller than the dimensions of the beads making up the ion exchange resin A. Preferably, the second sieve may be made from the same material as the rest of the cover 20, making it easier to recycle.

According to an advantageous implementation, the longitudinal dimensions of the lower section 25b are at least equal to the longitudinal dimensions of the upper section 25a. So, even if the upper section 25a and the lower section 25b have similar dimensions, this means that the fluid F is forced to reach halfway up the internal cavity 16 before it may enter said internal cavity. When, for example, the degree of filling of the internal cavity 16 by the ion exchange resin A is greater than 80%, it is even more advantageous for the lower section 25b to have longitudinal dimensions which are at least 30%, preferably at least 40%, greater than the longitudinal dimensions of the upper section 25a. As the lower section 25b is longer than the upper section 25a, the fluid F is forced to travel a greater distance in the central well 25 before it may enter the internal cavity 16. Whichever configuration is chosen, account should be taken, where appropriate, of the space occupied by the first longitudinal end 11 of the body on the first longitudinal end 28 of the central well, which preferably follows its contours.

According to a particular implementation illustrated in FIGS. 4a and 4b, the platform 21 and the central well 25 are formed in one-part. In other words, the platform 21 is secured to the central well 25.

Alternatively, as shown in FIG. 9, the platform 21 and the central well 25 are separate parts. In other words, the platform 21 and the central well 25 are supplied separately. In this variant embodiment, although the platform 21 is always connected to the central well 25 by the joining 20a, the platform 21 and the central well 25 each comprise, at the level of said joining 20a, complementary attachment means 210, 250. This allows to reduce the longitudinal dimensions of the central well 25, making the cartridge 8 more compact. In addition, as the platform 21 and the central well 25 may be manufactured independently of each other, they may also be recycled independently rather than being recycled as a whole.

In this respect, the platform 21 comprises a first complementary means 210 for attachment to the central well 25, while the central well 25 comprises a second complementary means 250 for attachment. By way of illustrative example, the first complementary means 210 may consist of a male tubular element projecting from the upper face 21a of the platform 21, while the second complementary means 250 may consist of a female tubular element extending from the second end 29 of the central well 25 and into which the male tubular element 210 of the platform 21 may be inserted.

This being said, it may be envisaged that the first complementary means 210 consists of a female tubular element projecting from the upper face 21a of the platform 21, while the second complementary means 250 consists of a male tubular element extending from the second end 29 of the central well 25 and able to be inserted into the female tubular element 210 of the platform.

Other complementary means for attaching the platform 21 to the central well 25 known to the person skilled in the art may be envisaged without prejudice to the inventive concept behind the present disclosure.

Referring now to FIGS. 5a to 5c, we will describe the means of assembling the cartridge 8 and the cover 20 and the various assembly steps. The mounting of the cartridge on the base 2 has already been described.

According to an example embodiment illustrated in the figures, the platform 21 comprises first hooking means 22 capable of cooperating with complementary second hooking means 17 for the cartridge 8 so as to allow the cover 20 to be attached in the cartridge 8. Still according to this example embodiment, the first means 22 for hooking the platform consist of protuberances 22a, 22c separated by a first space 22b. The second means 17 for hooking the cartridge consist of notches 17a, 17c and a leg 17b. The second hooking means 17 are provided at the level of the second longitudinal end 12 of the body.

To attach the cover 20 to the cartridge 8, the cover 20 is inserted into the cartridge 8 by pushing the central well 25 into the internal cavity 16. When the platform 21 is close to the second longitudinal end 12 of the body, the user must exert a slight pressure on the cover 20 so that the first hooking means 22 clip onto the second hooking means 17. During clipping, a first protuberance 22a engages in a first notch 17a, while at the same time a second protuberance 22c engages in a second notch 17c and the leg 17b engages in the first space 22b. The cooperation of such first hooking means 22 with such second hooking means 17 allows to attach the cover 20 to the cartridge 8.

In addition, according to a non-illustrated example embodiment, the first hooking means and the second hooking means could be reversed, i.e. the first hooking means could consist of notches and a leg while the second hooking means could consist of protuberances separated by a first space. Other means of attaching the cover 20 to the cartridge 8 could be envisaged without prejudice to the deioniser 1 according to the first aspect of the present disclosure.

At the end of the clipping step, a lower annular rim 21b of the cover rests on an annular rim 12a of the second longitudinal end 12. In addition, the first longitudinal end 28 of the central well rests on the first longitudinal end 11 of the body.

It should be noted that when the attachment of the cover 20 to the cartridge 8 is not associated with filling the cartridge 8 or, at least when the internal cavity 16 is empty, these steps may be implemented without the cartridge 8 being turned upside down, as may be seen in the figures. In other words, it is not necessary to orientate the cartridge 8, as shown in the figures, if the internal cavity 16 is empty or needs to be temporarily kept empty.

We will now describe the various steps involved in filling a deioniser 1 as described above, in particular a cartridge 8 of such a deioniser.

In this respect and as a preliminary, it is particularly advantageous for the second longitudinal end 12 of the body to comprise lateral openings 15 for loading the ion exchange resin A. These lateral openings 15 are therefore preferably of a size suitable for introducing the beads forming the ion exchange resin A. As a reminder, the resin beads are generally between 0.2 mm and 2 mm in size. To make it easier to load the beads, the loading openings 15 should be at least 3 to 7 times larger than the dimensions of a single bead. It is also advantageous that the platform 21 and the cover 8 comprise, respectively, the first means 22 for hooking to the cover 8 and the second means 17 for hooking to the platform 21 so that they may be attached.

In a first step 110, a cartridge 8 and a cover 20 as described above are provided. When the platform 21 and the central well 25 are separate, and therefore supplied separately, the platform 21 is attached to the central well 25 by means of complementary attachment means 210, 250 if the platform 21 and the central well 25 are not assembled.

In a second step 120, the cover 20 is moved into a position, referred to as the filling position, wherein the second hooking means 17 are free and the lateral openings 15 are open so as to give access to the internal cavity 16 for filling. The second hooking means 17 are said to be “free” as opposed to a situation wherein they are engaged with the first hooking means 22. During this step, it is preferable, initially, to arrange the cartridge 8 vertically so that the first longitudinal end 11 of the body is oriented towards the ground, and is therefore closer to the ground than the other parts of the cartridge. The cover 20 is then positioned so that the central well 25 is inside the internal cavity 16, ensuring that the second 17 hooking means are free and the lateral openings 15 are open. This position is best seen in FIG. 5a. This position is natural as the protuberances project radially over the annular rim 12a. In this respect, the platform 21 may advantageously be dimensioned so that the annular edge 12a retains the protuberance 22a when no pressure is exerted on the cover 20, i.e. when the cover 20 is simply placed on the cartridge 8.

In a third step 130, the internal cavity 16 is filled with ion exchange resin A through the lateral openings 15 as shown in FIG. 5b. During this step, it is preferable to maintain the cartridge 8 in a vertical position wherein the first longitudinal end 11 of the body is oriented towards the ground. In addition, preferably the quantity of resin A to be loaded is predetermined so that the quantity of resin A is suitable for controlling the conductivity of the fluid F, the quantity of resin A is suitable for holding the beads compactly, and the quantity of resin A loaded does not prevent the cover 20 from being attached to the cartridge 8 in the next step.

In a fourth step, the cartridge 8 is closed by means of the cover 20. In this respect, a simple movement of pressing on the cover 20 by translation along the longitudinal axis X allows the cover 20 to cooperate with the cartridge 8. Advantageously, closing the cartridge 8 causes the ion exchange resin A in the internal cavity 16 to settle or even compress. This allows to ensure that the beads of the resin A remain compact. During this step, and as already seen previously, the first protuberance 22a engages in the first notch 17a, while at the same time the second protuberance 22c engages in the second notch 17c and the leg 17b engages in the first space 22b. The cover 20 is then in a position, referred to as the use position, wherein the second hooking means 17 are engaged with the first hooking means 22 and wherein the lateral openings 15 are closed by the platform 21.

Although it is advantageous to fill the deioniser 1 via the lateral openings 15, this is not compulsory. The deioniser 1 may be filled by pouring ion exchange resin A directly into the internal cavity 16. However, this variant is less practical than the previously described embodiment using lateral openings 15, as it requires the excess resin A that penetrates the central well 25 to be removed when it is inserted into the internal cavity 16.

According to a second aspect, the disclosure also relates to a filter 1′ for a fluid circuit 50. Examples of fluid circuits 50 were described at the beginning of the detailed description and are not repeated here. In the remainder of this description, the filter according to the second aspect of the disclosure will be described in more detail. The filter 1′ may be any type of filter well known to the person skilled in the art, for example a particle filter (bacteria, contaminants, etc.) for treating water used for aquatic or recreational activities, industry, etc. The filter resin A′ may take any form known in the trade. Preferably, the filter resin A′ is in the form of beads with dimensions of between 0.2 and 2 mm.

The filter 1′ comprises a cartridge 8 comprising a body 10 and a cover 20.

The body 10 has a generally tubular shape along a longitudinal axis X. The body 10 comprises a closed first longitudinal end 11 and a second longitudinal end 12 which is configured to be attached to the cover 20. According to one example of the embodiment of the filter 1′, the filter 1′ is a fixed filter. In this case, the body 10 comprises a fluid inlet port 3 and a fluid outlet port 4, said inlet and outlet ports being directly connected to the fluid circuit 50. Alternatively, the filter 1′ is a cartridge filter. In this respect, the filter 1′ comprises a base 2 for fluid connection to the fluid circuit, this base 2 comprising the fluid inlet port 3 and the fluid outlet port 4. In this variant embodiment, the cartridge 8 is configured to be removably attached to the base 2. In this respect, the base 2 may comprise an attachment interface 5, located close to an upper edge of said base, to which the cartridge 8 may be attached. The description of the first aspect of the disclosure describes in detail how the cartridge 8 may be attached to the base 2 by means of such an attachment interface 5.

The body 10 comprises an internal storage cavity 16 capable of storing a filtering resin A′ in a quantity suitable for exchange with the fluid F as it passes through the cartridge 8. The filter resin A′ is not limited to a particular type of resin. It is adapted to the use to be made of the filter 1′ according to this second aspect of the disclosure. By way of example, the filtering resin A′ may be made from one or more decontaminating, bactericidal, virucidal materials, etc. In a particular embodiment, the filtering resin A′ is an ion exchange resin and is therefore suitable for a filter 1′ of the deioniser type.

The cover 20 is configured to be attached to the second longitudinal end 12 of the body. In this respect, as we shall see later, the cover 20 and the cartridge 8 may advantageously comprise complementary hooking means. The cover 20 comprises a platform 21 that alternately opens and closes the second longitudinal end 12 of the body and, with it, the internal cavity 16, since the other end, i.e. the first longitudinal end 11 of the body, is closed. According to a preferred embodiment, the platform 21 extends transversely with respect to the longitudinal axis X. It comprises an upper face 21a delimited by a peripheral rim 21b extending around the longitudinal axis X. Preferably, the upper face 21a has a circular shape and is centered around the longitudinal axis X. Advantageously, the peripheral rim 21b has a shape that matches an inner rim of the cartridge, allowing it to be as close as possible to the cartridge 8, and even to be in scaled contact with the cartridge 8. In this respect, it is advantageous for the dimensions of the platform 21 to be chosen appropriately to allow a precise adjustment of the cover 20 in the cartridge 8 once this cover 20 is mounted in the cartridge.

In a preferred embodiment, the cover 20 also plays a role in distributing the fluid F through the filter 1′ and the fluid circuit 50. In this respect, the platform 21 may comprise first orifices 23 configured to allow the fluid F to pass from said internal cavity 16 towards the outlet port 4. These first orifices 23 are not described in detail and reference is made to the description relating to the first aspect of the disclosure which presents other possible characteristics of these first orifices 23. In addition, still relating to the distribution of the fluid F in the filter 1′ and the fluid circuit 50, the platform 21 may be connected to a central well 25 having a generally tubular shape along the longitudinal axis X which extends inside the body 10. The central well 25 may advantageously comprise second orifices 27a, 27b, 27c to allow the fluid F to pass from this central well 25 into the internal cavity 16. These second orifices 27a, 27b, 27c are not described in detail and reference is made to the description relating to the first aspect of the disclosure which presents other possible characteristics of these second orifices.

According to the second aspect of the disclosure, the second longitudinal end 12 of the body comprises lateral openings 15 in the filter resin A′. The lateral openings 15 are used to load the filter resin A′ into the internal cavity 16. These lateral openings 15 are therefore appropriately sized so that the filter resin, whatever its shape, may be inserted into the internal cavity 16.

Still according to this second aspect of the disclosure, the cover 20 is configured to move in translation along the longitudinal axis X from a filling position, wherein the lateral openings 15 are open so as to allow the internal cavity 16 to be filled, to a use position, wherein the lateral openings 15 are closed by the platform 21 of the cover. Thus, when the cover 20 is in the filling position and the lateral openings 15 are open, the filter resin A′ may be loaded into the internal cavity 16 by any suitable means, whereas when the cover 20 is in the use position and the lateral openings 15 are closed by the platform 21, it is impossible to gain access to the internal cavity 16 in this way. Moreover, in this position of use, in addition to the lateral openings 15, the second longitudinal end 12 of the body is also closed. When the cartridge 8 reaches this position of use, this advantageously causes the filtering resin A′ to be compacted or even compressed in the internal cavity 16, which ensures that the filtering resin A′ remains compact in the internal cavity.

The filter 1′ according to this second aspect of the disclosure overcomes many of the disadvantages of filters in the prior art. In filters based on the prior art, the internal cavity may only be loaded/filled via the bottom of the internal cavity, which is removable. This bottom, which may be likened to a cover, is generally made up of several parts which must first be separated from the filter so that the filter resin may be loaded into the internal cavity. Generally speaking, removing these parts requires tedious operations that may be particularly complex. Reassembling these parts in the filter may also be tedious and very complex. The filter 1′ according to the second aspect of the disclosure not only allows the internal cavity to be filled easily, but also allows the cover 20 to be mounted subsequently simply by the user pressing on it. The filter 1′ is therefore particularly easy to use. The position of the openings 15, i.e. laterally at the level of the second longitudinal end 12 of the body, is therefore particularly suitable for filling to be performed simply and without having to perform complex and numerous operations to mount or refit the cover 20.

An example of a filter 1′ is shown in FIGS. 5a to 5c, which successively show the cover 20 in the filling position (FIGS. 5a and 5b) and in the operating position (FIG. 5c). Depending on the configuration of the filter 1′, it may be necessary to turn the filter 1′ upside down to prevent the filter resin A′ from falling out during loading or exerting too much pressure on the cover 20 during loading. In this respect, the lateral openings 15 are not necessarily located at the level of the second longitudinal end 12 of the body, although this is more practical if it is desired to facilitate complete filling of the internal cavity 16 with filter resin. In a particular implementation, the cartridge 8 comprises two diametrically opposed openings 15, which allows the cover 20 to be sufficiently attached to the cartridge 8 and the cover to be easily manufactured.

According to a third aspect, the disclosure also relates to a method 100 for filling a filter 1′ according to the second aspect of the disclosure. The method 100 according to this third aspect of the disclosure comprises the following steps in this order:
110) providing a filter 1′ according to the second aspect of the disclosure,
120) putting the cover 20 in the filling position,
130) filling the internal cavity 16 with the filter resin A′ by means of the lateral openings 15, and
140) closing the cartridge 8 by means of the cover 20.

The filling method 100 according to the third aspect of the disclosure allows to overcome many of the disadvantages of filling methods known in the prior art. At the end of step 130), as the cover 20 is pre-positioned on the cartridge 8, it is possible to fill the inner cavity with the filter resin A′ without the need to use any masking element, unlike the methods of the prior art, for example those described in the document JP-A-2021137771. The implementation of this method with a filter—as previously seen-which comprises a cover 20 that leaves the lateral openings 15 open when it is in the filling position and closes said lateral openings 15 when it is in the position of use, allows to perform filling simply and with a very small number of operations.

In this respect and according to an example embodiment illustrated in FIG. 5a, the cover 20 comprises at least one pattern 30 for marking the filling position and the use position, this pattern 30 being arranged so that, in the filling position, the pattern is entirely visible, and in the use position, the pattern is partially visible. This allows the user to quickly assess the position of the cover 20 in relation to that of the cartridge 8, which may be particularly useful when several fluid circuits 50 need to be serviced. In this case, the reason indicates “not filled”. It is fully visible in the filled position, whereas in the use position only the word ‘filled’ is visible. It is therefore possible to quickly identify the state of the cartridge 8, i.e. filled/unfilled.

In addition, in the case where the platform 21 is connected to a central well 25 comprising second orifices 27a, 27b, 27c, it is advantageous for these second orifices to be covered with a sieve which allows the filter resin A′ to be retained outside the central well during loading. Furthermore, it is also advantageous for the first longitudinal end 28 of the central well to be dimensioned so that it is already engaged in the first longitudinal end 11 of the body when the cover 20 is in the position of use. This prevents the filter resin A′ from blocking the cover closure. No additional masking element is required at the level of the second longitudinal end 12 of the body to prevent the resin A′ from penetrating into the central well 25, unlike in the prior art.

According to a particular implementation, the platform 21 comprises first means 22 for hooking to the cartridge 8 and the second end 12 of the body comprises second means 17 for hooking to the platform 21. The first 22 and second 17 hooking means are free when the cover 20 is in the filling position, while the second hooking means 17 are engaged with the first hooking means 22 when the cover 20 is in the use position. Thus, during step 140, the cartridge 8 may be closed by the cover by causing the second hooking means 17 and the first hooking means 22 to cooperate so that the second hooking means 22 are engaged with the first hooking means 17 when the cover 20 reaches the position of use.

Preferably, one of the elements chosen from the first hooking means 22 and the second hooking means 17 comprises protuberances 22a, 22c, and the other of these elements comprises notches 17a, 17c. The second hooking means 17 could therefore be located on the cover 20, while the first hooking means 22 could conversely be located on the cartridge 8, in particular at the level of the second longitudinal end 12 of the body. Whichever configuration is chosen, the protuberances 22a, 22c are then preferably configured to cooperate by resilient snap-fitting with the notches 17a, 17b to ensure the attachment of the elements together. By fitting into the first notches 17a, the first protuberances 22a allow the cover 20 to be locked angularly with respect to the cartridge 8, which is particularly advantageous when the cover 20 is in the position of use. The same applies when the second protuberances 22c are inserted into the second notches 17c.

In addition, the first protuberances 22a are respectively separated from the second protuberances 22c by spaces 22b, the hooking means 17 comprise legs 17b capable of being inserted into the spaces 22b so as to lock the cover 20 longitudinally with respect to the body 10 when the cover 20 is in the position of use. The cooperation of the legs 17b with the spaces 22b makes it even easier to attach the cover 20 to the cartridge by preventing the cover 20 from moving along the longitudinal axis X once it is attached to the cartridge. In other words, the cooperation of the legs 17b and spaces 22b locks the cover 20 longitudinally with respect to the cartridge 8.

Other means of attaching the cover 20 to the cartridge 8 may be envisaged, but the first hooking means 22 and the second hooking means 17 as described above allow to secure the attachment of the cover 20 to the cartridge 8 reliably while allowing easy removal of the cover 20. The cover 20 may be separated from the cartridge 8 by exerting a pressure on the second protuberance 22c (pressed into the second notch 17c, e.g. FIG. 5c) above a predetermined threshold. The stress thus generated on the cover 20 dislodges the leg 17b from the space 22b and the first protuberance 22a from the first notch 17a.

According to a particular implementation and as may be seen in the figures, the first notches 17a extend from a first annular rim 12a on an internal surface of the body 10. The fact that the first notches 17a are close to the first annular rim 12a allows to reduce the stresses exerted by the cover 20 on the cartridge 8 when said cover 20 moves from the filling position to the use position.

In another particular implementation, the platform 21 comprises a second annular rim 31 projecting from an external surface of the platform so that in the filling position, this second annular rim 31 abuts the first annular rim 12a. Thus, when the cover 20 reaches the position of use, it is held both by the first 17 and second 22 hooking means and by the second annular rim 31. The latter is also a means of locking the cover 20 in translation relative to the cartridge 8. It marks the position of end-of-stroke of the cover.

The configurations shown in the figures are only possible examples, and by no means limitative, of the disclosure which, on the contrary, encompasses all the design variants available to a person skilled in the art.

1. A deioniser for a fluid circuit, the deionizer comprising:
a fluid connection base suitable for being connected to a fluid circuit, this base comprising a fluid inlet port, a fluid outlet port and an attachment interface, and
a cartridge comprising a body and a cover, the body being generally tubular along a longitudinal axis (X), and comprising a first closed longitudinal end and a second longitudinal end which is configured to be attached to the attachment interface of the base, the body comprising an internal storage cavity suitable for storing an ion exchange resin (A), the cover being configured to be attached to the second longitudinal end of the body and comprising a platform connected to a central well,
the platform extending transversely with respect to the longitudinal axis (X) and closing the second end of the body and the internal cavity, this platform comprising first orifices covered by a first sieve or comprising this first sieve, the first orifices being configured to allow a fluid (F) to pass from the internal cavity towards the outlet port, and the first sieve being configured to retain the resin and prevent it from leaving the internal cavity, and
the central well extending inside the body and having a generally tubular shape along the longitudinal axis (X), the central well comprising a first closed longitudinal end located on a side of the first longitudinal end of the body, and a second longitudinal end which is connected to the platform and which is fluidly connected to the inlet port, the central well comprising two sections adjacent between its first and second longitudinal ends, an upper section located on a side of the first end and comprising second orifices covered by a second sieve or comprising this second sieve, the second orifices being configured to allow the fluid (F) to pass from the central well into the internal cavity, and the second sieve being configured to retain the resin (A) and prevent it from leaving the internal cavity, and a lower section which is located on a side of the second end and which is devoid of orifices.

2. The deioniser according to claim 1, wherein the second orifices have increasing diameters (d₁, d₂, d₃) along the longitudinal axis (X), the second orifices having the largest diameters being proximal to the first end while the second orifices having the smallest diameters being distal to the first end.

3. The deioniser according to claim 1, wherein the second orifices have dimensions, along the longitudinal axis (X), differing by no more than 10% from the dimensions, along a transverse axis (Y), of the central well and of the inlet port.

4. The deioniser according to claim 1, wherein the second orifices are angularly distributed around a circumference of the central well.

5. The deioniser according to claim 4, wherein the second orifices form annular rows of second orifices around the circumference of the central well, the second orifices in the same annular row being angularly spaced at an angle of 180°.

6. The deioniser according to claim 1, wherein the longitudinal dimensions of the lower section are at least equal to the longitudinal dimensions of the upper section.

7. The deioniser according to claim 6, wherein the central well comprises between four and ten first orifices.

8. The deioniser according to claim 1, wherein the first orifices are uniformly distributed around the central well, the first orifices having substantially the same diameter or the same transverse dimension.

9. The deioniser according to claim 1, wherein the platform comprises an upper face, of circular shape, delimited by a peripheral rim extending around the longitudinal axis (X), this peripheral rim having a cylindrical shape matching an inner rim of the second longitudinal end of the cartridge, the first orifices being formed in the upper face.

10. The deioniser according to claim 1, further comprising a discharge cavity formed by the platform and the base, the discharge cavity extending around the inlet port.

11. The deioniser according to claim 1, wherein the inlet port comprises a channel for connecting the inlet port to the central well, the connecting channel being substantially straight and opening at a level of the second longitudinal end of the central well.

12. The deioniser according to claim 1, wherein the base comprises a multi-way valve for connecting the deioniser to the fluid circuit.

13. The deioniser according to claim 1, wherein the body comprises a dome, located at a level of a first end, this dome being configured to receive the first end of the central well, the body further comprising an air drain hole and a plug configured to be attached to the air drain hole, the air drain hole and the plug being located at a top of the dome.

14. The deioniser according to claim 1, wherein the second end of the body comprises first attachment means, and wherein the attachment interface comprises second attachment means complementary to the first attachment means and suitable to cooperate with the first attachment means.

15. The deioniser according to claim 1, wherein the platform comprises first means for hooking to the cartridge, and the second end of the body comprises openings for loading an ion-exchange resin (A) and second means for hooking to the platform, the cover being configured to move between a filling position wherein the hooking means are free and the openings are open so as to give access to the internal cavity for filling, and a use position, wherein the second hooking means are engaged with the first hooking means and the openings are closed by the platform, by translation of longitudinal axis (X).

16. The deioniser according to claim 1, wherein the platform and the central well are formed in one-part.

17. The deioniser according to claim 1, wherein the platform and the central well are separate parts.

18. A fluid circuit for a vehicle, comprising:
a stack of fuel cells;
a heat exchanger; and
the deioniser according to claim 1.

19. A method for filling the deioniser according to claim 1, the method comprising the following steps in this order:
providing a cartridge and a cover of the deioniser;
placing the cover in a filling position, filling the internal cavity with ion exchange resin (A); and
closing the cartridge using the cover.
